(19) United States
(12) Patent Application Publication
(10) Pub. No.: US 2004/0245429 A1
(43) Pub. Date: Dec. 9, 2004

(54) Mould equipment for concrete casting and a method for making the mould equipment

(76) Inventors: Jesper Bjrn Rasmussen, Brabrand (DK); Erik Spangenberg, Braedstrup (DK)

Correspondence Address: James C Wray, Suite 300, 1493 Chain Bridge Road, McLean, VA, 22101, US

(21) Appl. No.: 10/495,983

(22) PCT Filed: Nov. 14, 2002
(86) PCT No.: PCT/DK02/00762

(30) Foreign Application Priority Data
Nov. 19, 2001 (DK) PA 2001 01719

(51) Int. Cl. B28B 7/24

(52) U.S. Cl. 249/119

(57) ABSTRACT

A mold equipment for casting block bricks includes a lower part with casting cells corresponding to shapes of the blocks brick and upper part with foot plates projecting downward on carrier tubes with thrust plates mainly corresponding to the shape of the molding cells, the undersides having thrust plates. The mold equipment is made of cut-out, welded steel parts that eventually form main parts of the mold equipment by welding and bolting. ?A method for making a mold equipment has in its individual part, or more thereof, shaped as the upper part, or large single parts thereof, such as carrier tubes, pressing feet, thrust plates, and the mold lower part has a mold table and the mold insert, all of which are cast in at least one casting process. This avoids some work operations and material in the form of steel is saved.

The present invention concerns a method for making would equipment for concrete casting machines of the kind typically used for making block bricks for pavement and wall construction, and including an lower part constituted by a mould table in which is provided at least one cell divided mould insert with cells that are open upwards as well as downwards, the cells defining the desired basic shape of individual bricks, and a corresponding upper part that includes a top rail from a top plate and has pressing pistons in the shape of legs projecting downward from at least one intermediate plate and provided with foot plates, the undersides of which include lower thrust plates interacting with respective underlying cells in the lower part and thereby are useful counter hold for the castings during vibration and for downward ejection of the castings from the cells.

The invention also concerns a mould equipment of the kind indicated.

The equipment is used in the way that the lower part is placed on a mould board disposed upon a vibration table with the upper part lying in an elevated position above the lower part. A concrete supply vehicle is guided in along the upper side of the lower part in the space below the upper part for pouring concrete into the mould cells for filling these with concrete. After finished filling, the supply vehicle is drawn out, and the upper part is lowered until the said thin plates hits the concrete surfaces in respective mould cells. Then the upper part is used as a multi-pressure piston for compressing the concrete mass in individual mould cells, which occurs under strong vibration of the mould equipment for separating air from the concrete mass. Hereby, the mould items are compressed to the desired compact block shape and uniform thickness. Then the upper part is held at its final level relative to the lower part, and the lower part is acted on by force for lifting up from the mould board, whereby the mould items, which by the pressure maintained from the upper part cannot participate in this elevation, will remain standing on the mould board during the ejection concerned. When ejection has been completed at the elevation of the lower part to a position in which its lower side is lifted to the level of the thrust plates of the upper part, the semi-solid mould items may be removed from the vibration table by pushing out thereof after lifting the upper part, whereafter a new moulding cycle can be commenced after lowering the lower part to the mould board and lifting the upper part to its staring position.

The process itself for making concrete products is a vibration process where large vibratory forces are supplied, acting on both upper and lower parts of the mould equipment. In order to resist the large vibratory forces that act on the mould equipment during use, this is built up of very strong steel. Traditionally, the upper part contains many welded parts which are either welded or bolted together for making the assembled unit. As a result of said vibratory forces, great demands are made to the weldings used for joining the individual part constituting the main parts of the mould equipment, which i.a. means that the production costs in connection with the making of the upper and lower parts of a mould equipment are very large. Furthermore, most often there will be residual stresses in the material (steel) of which the mould equipment is made after the welding process which often imply need for annealing before putting the mould equipment into use which further increases the production costs for said mould equipment.

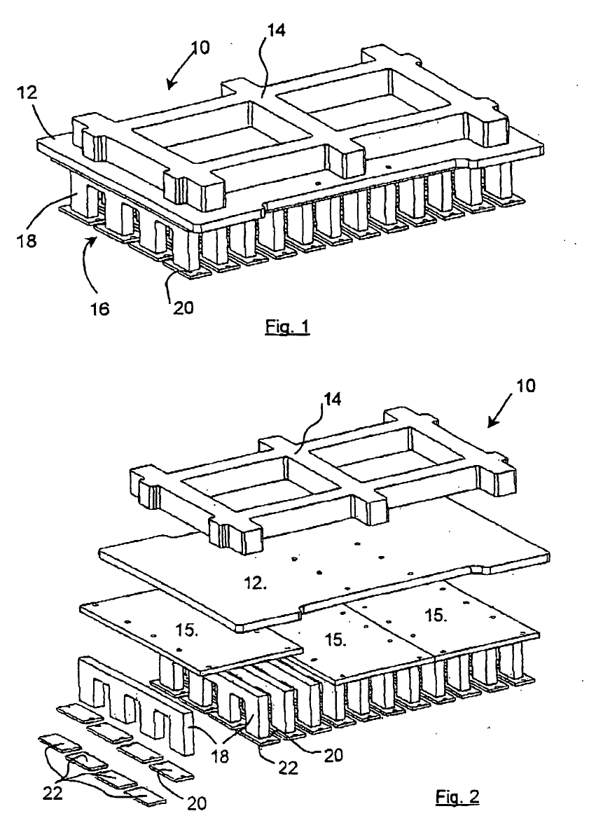

An example of an upper part o a mould is shown in FIGS. 1 and 2 showing a traditionally structured upper part in assembled (FIG. 1) and exploded (FIG. 2) view, respectively.

It goes without saying that such traditionally structured mould equipments are even exceptionally expensive to make, as all parts have to go through finishing treatment after cutting from steel plate material and welding into individual parts, before the parts in turn are assembled to main parts by welding or bolting together. The work operations are, as hinted, many and work demanding, and, in spite of optimisation measures, there is a great waste of material in connection with the cutting of the parts. An example of this is the making of the cell divided mould insert which is made of solid steel plate where the cells are formed by holes flame cut from the plate material, and where the cut material has to be discarded. Furthermore, the environment consequences of the production processes have to be considered, e.g. the amount of energy used, not only for cutting out the mould inserts but also for cutting out the other constituent parts in the mould equipment, welding and machining thereof, and transport of steel and scrap to and from the site of production of the mould equipment. Thus, we are speaking of very significant amounts of energy which, in light of the international agreements on nations' energy consumption in the industrialised part of the world, are desired to be reduced the most possible.

The large production costs and thereby acquiring costs for such mould equipment imply that the users of this (producers of paving and block bricks) make great demands for a long tool life for it Exactly the tool life for the mould equipment may be a sensitive subject within the industry producing paving and block bricks, as the mould equipment is eventually worn so much during use that too great deviations from standard dimensions or from dimensions indicated by producer for the items moulded in the mould equipment may occur, which may cause not insignificant problems for the purchasers of the items.

The acquisition costs for the mould equipment also influences the will/ability to acquire more mould equipment units for making e.g. paving bricks with alternative designs compared with the usual shapes thereof, and with the present high level of cost, the will/ability of acquiring or making mould equipment for making brick designs with not yet tested market possibilities is very small. This is probably the most important reason for the assortment of variants of paving bricks in usual retail being relatively limited.

It is the purpose of the invention to indicate a method for making a mould equipment which is work saving and at the same time provides possibility for even large resource savings with regard to consumption of materials and energy.

This will be possible with a mould equipment of kind indicated in the introduction which is characterised in that the individual parts comprised by the mould equipment, including such as top plate, top rail, upper part, legs, foot plates, thrust plates, mould table, cell divided mould insert or inserts, lower part, are cast in at least one casting process.

Hereby is achieved that only the material needed for making the said parts is used, which means a not inessential saving of materials in the form of the material which by the prior art method is cut out from virgin plate material and is discarded for scrapping. Furthermore, with a mould equipment according to the invention it will be a design practically without weldings, which means that the weakening of the material in the mould equipment arising immediately outside the welding zone by making the mould equipment according to the prior art is avoided, as no weldings at all are present.

Furthermore, compared with prior art method, the mould equipment according to the invention will provide possibilities for considerable energy savings in connection with making the types of steel plates used for producing the mould equipment according to the prior art method and for transporting the said steel plates from the production site of the steel plates to the place for which the mould equipment is produced. Besides, compared with the prior art method, there will be savings in the form of power used for welding, welding rods and power consumption for relieving contamination in connection with performing the weldings. Furthermore, there will be savings of energy, resources and contamination limiting measures in connection with the sub-supplier stage which by making the steel plate that otherwise would have been used for making the mould equipment.

Summarising, the said savings will contribute to reduce the acquisition cost on the mould equipment, and this means that we may operate with shorter tool lives for the mould equipment comprised by the invention, which means that the products made with the mould equipment will be more uniform, as the mould equipment will be substituted in due time.

A further possibility provided for when the technique concerning the mould equipment according to the invention is fully implemented and optimised is that there will be a greater tendency/will/ability on the part of the brick producers to attempt making and marketing new variants of the moulded items as a consequence of the reduced costs for making the mould equipment.

Moulding of the individual parts, or moulding of these into larger units according to the method, may be expanded according to need to include the entire upper and lower parts as indicated in claims 2-6.

It is to be further underlined that the invention is not limited to include the whole mould upper or lower parts, but it is intended that the cast parts can be mounted together with other parts of the mould equipment which is made in a traditional way, which implies large flexibility with regard to using the new mould parts in connection with the mould equipment previously made.

It is preferred, as indicated in claim 7, that the individual parts/items are formed by a cast iron alloy. The alloy of the cast iron may, according to the desired ductility of the item formed, be adapted to the purpose. For example, the requirements to the ductility of the cast iron will be the greatest at the thrust plates, the pressing feet and in the cell divided mould insert. These items may e.g. be cast as single units which subsequently are bolted to the other mould parts that also way be formed by casting, however using another cast iron alloy.

After the casting procedure has been finished, and the cast items have been ejected, finishing treatment is typically performed as indicated in claims 8 and 9. Hereby is achieved that the surfaces on the cast items have approximately the same quality and nature that may be attained by making the mould equipment according to the traditionally used method by welded, cut-out individual items of strong steel plates.

With the purpose of ensuring a reasonable tool life for the mould equipment according to the inventive method, there may advantageously be performed tempering of the wear parts of the mould equipment as it appears from claim 10. Alternatively, said wear parts may be coated with carbide as it appears from claim 11. In that connection it is to be mentioned that when speaking of wear parts, they are in particular the foot plates and/or thrust plates in the upper part, and the individual cells in the mould insert where cell walls and upper edges of the partitionings between individual cells.

Moulding of the complete upper part of the mould equipment is effected by a mould including at the top a first upper mould part having the shape of the top rail on the upper part plate with the roundings that are to be at the transition from top rail to the upper part plate. The mould also includes a second mould part in the shape of a fame internally having the shape and thickness of the upper part plate. At the bottom, the mould is closed with a row of moulds held together, each constituting a leg with bolt plate or with thrust plate. These mould elements are held in place by profilings in individual moulds ensuring that the mould element is lying correctly. These mould elements also have the desired roundings at the transitions to the upper part plate. The mould elements are held together by a frame which in turn is held together with the first and second upper mould parts, respectively. The mould thus held together is filled with liquid cast iron with the desired composition. After cooling, the two upper mould parts are removed. The lowermost mould parts held together may not be removed as in one, but are broken and the complete upper part is ejected.

Optionally, it may be chosen only to cast the upper part plate with reinforcement, the second upper mould part being closed at the bottom with a plane mould part. Individual legs are thus moulded separately in each their mould held together which according to a preferred embodiment is formed for bolt plate at both ends of the leg, or bolt plate at one end and thrust plate at the other end. The cast legs are then bolted fast onto the counter hold plate.

Casting of the complete lower part of the mould equipment occurs by an under mould where the mould insert is moulded by the under mould, which has the desired outer contour, is provided with a suitable number of cores with the desired brick shape (there is a small allowance for machining as it is necessary to clean the surface of the mould holes before tempering). These cores are secured in the upper and lower parts of the under mould.

The individual parts in a mould equipment made according to the method are, as regards the entire mould upper part or its individual parts, specified in the characterising part of claim 12. Here is stated that individual parts in the mould upper part may be made by moulding as independent units intended for subsequent machining and assembling, including relevant parts cast in one piece that are subsequently assembled by bolts or welded together, respectively. In that connection, the possibility of combining the cast mould equipment parts with mould equipment parts made according to prior art, including cut-out, welded/bolted would parts, has not been abandoned.

With the purpose of providing different surfaces and structures on the items made with the mould equipment according to the invention, the sides of the thrust plates facing the mould table may be shaped as indicated in claim 13. Hereby is achieved that there may be different patterns and shapes on the thrust plate so that the moulded bricks on a mould board have different surfaces/structures. Such bricks are particularly attractive, simply because it provides an appearance similar in shape to natural stones—each brick has its own surface shape which of course is repeated for each board with moulded items equipped from the mould equipment. However, this is different in cases where said bricks from such production are manually laid out, as here is substantially left the impression that the bricks are made individually (cut).

In this connection it is realised that shaping the said sides of the thrust plates with recesses and projections is known from the traditional method of making mould equipment of the kind indicated, but where the said recesses and projection have been provided by milling which is a very expensive method.

In claims 14 to 17 is indicated how a lower part of a mould equipment according to the invention may appear, but also here it is noted that the individual parts in the mould lower part may be made by casting as independent units intended for subsequent machining and assembly, or that the mould upper part may be formed by e.g. two or more main parts, including the relevant units cast in one piece that subsequently are assembled with bolts, or welded together, respectively. In that connection, the possibility of combining the cast mould equipment parts with mould equipment parts made according to prior art, including cut-out, welded/bolted mould parts, has not been abandoned.

It is certain that the cast elements after section will include burrs, scales etc. to be removed before using the elements. This requires finishing treatment as indicated in claim 18. The finishing treatment may consist in grinding and/or sand blasting and/or polishing, or similar treatment.

With the purpose of attaining good wearability on the mould equipment, this may, as indicated in claim 19, be tempered in the wearing areas in upper part and lower part, respectively, which in practice will mean pressing feet in the shape of thrust plates and foot plates, and the cell walls in the mould insert of the lower part, and the upper sides of the partitionings between individual cells. Alternatively, the said wear areas in upper and lower part as indicated in claim 20 may be coated with carbide.

After a certain period of time, the mould equipment will, in spite of the tempering of the wearing parts, be so worn that it does no longer provide for the precision requirements made to mould items produced in it. In that connection, it will be relatively simple to reuse the worn mould equipment as this is simply returned to the foundry which remelts the steel to a new shape. Thus, this is a product which is 100% recyclable.

The invention is explained in more detail in the following with reference to the drawing, where:

FIG. 1 is a perspective view of a prior art mould upper part for a mould equipment,

FIG. 2 is an exploded view of the mould equipment shown in FIG. 1,

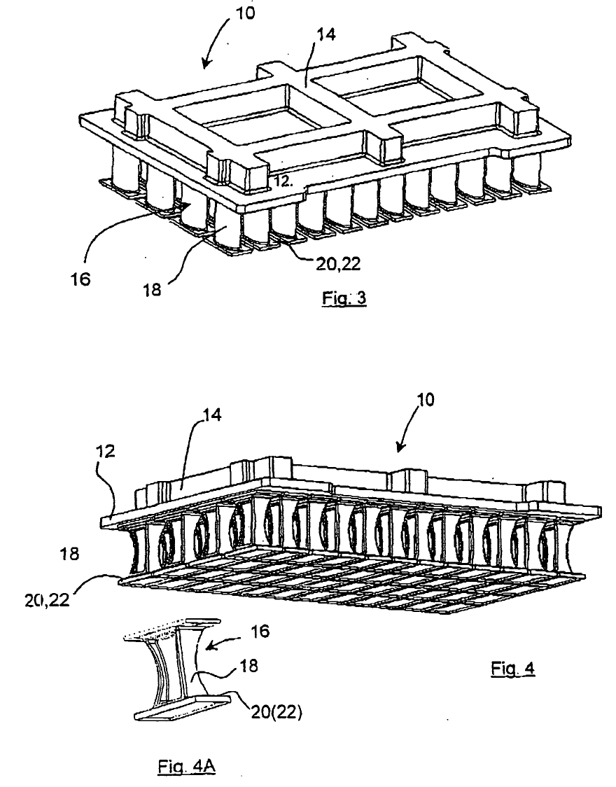

FIG. 3 is a perspective view as seen obliquely from above of an embodiment of a mould upper part according to the invention,

FIG. 4 is the same as FIG. 3, but viewed obliquely from below,

FIG. 4A is a perspective view of a thrust piston with foot plate according to the invention,

FIG. 5 shows a perspective view of a traditionally structured mould lower part,

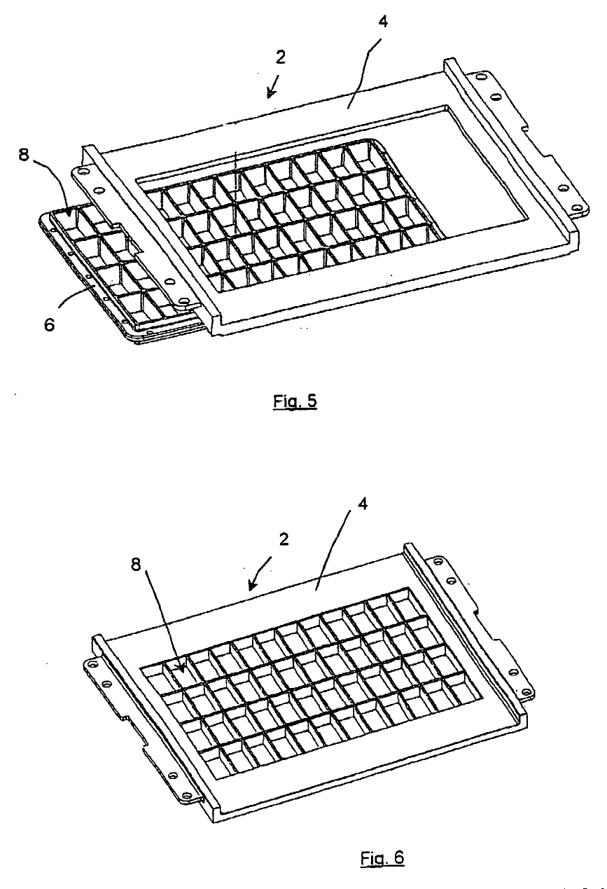

FIG. 6 is a perspective view of an embodiment of a mould lower part according to the invention, and

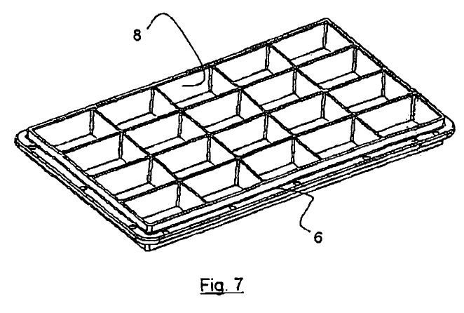

FIG. 7 shows a perspective view of the mould lower part shown in FIG. 5 in assembled state.

FIGS. 1 and 2 show a traditionally structured mould upper part 10 in assembled and exploded view, respectively. The mould upper pat 10 is traditionally constituted by a top plate 12 with a top rail 14. At the underside of the mould upper part there are intermediate plates 15 from which downward projecting pressing pistons 16 in the form of legs 18 that are terminated at the ends with foot plates 20 on which are fitted the real thrust plates 22 that interact with the cells 8 in the lower part 2 (see FIG. 5). The said parts of the mould upper part 10 is formed by flame cut sub elements which in turn are welded together so that they constitute the above discussed main parts of the mould upper part 10. Thus there are fairly many parts initially to be machined before they call be assembled by welding etc.

In FIG. 3 is shown an embodiment of a mould upper part 10 according to the invention, where this is expanded to its extreme form, as the entire mould upper part is cast in one piece I.e. the earlier single elements, like the top plate 12 with top rail 14, pressing pistons 16 in the shape of legs 18 which are terminated with foot plates 20, and the real pressing plates 22 are cast in one and the same piece, as the intermediate plates 15 are made redundant.

As also appearing from the stipulated claims, it will be possible to utilise the invention on more limited main parts as indicated in FIG. 4A, where a pressing piston 16 is shown, where legs 18, foot plate 20 and thrust plate 22 are cast in one and the same piece which subsequently may be mounted on e.g. a top plate 12 where this and the top rail 14 are cast in one piece.

The upper part 10 according to the invention and shown in FIG. 3 may also be cast as a unit where the foot plates 20 and/or the thrust plates 22 are cast in one and bolted on individual legs 18. These may be substituted following wear, either if they are worn before the mould insert 6 (see below) or simultaneously with the insert. Alternatively, the upper part 10 is cast in several pars (FIG. 4). This Figure shows an example where the upper part plate 12 and the top rail 14 are cast as a unit and the individual legs 18 (career tubes) with foot plates 20 and thrust plates 22 are cast as a unit. Alternatively the entire counter hold, including thrust plates 22, may be cast as a unit.

Traditionally, the lower part 2 consists of a mould table 4 which most often is welded together, but may consist of a cast mould frame in which a cell divided mould insert 6 is mounted. The mould insert 6 is the part of the mould which by it shape provides form and shape to the produced product. The mould insert may either be welded to or built together with the mould frame, but may also be made as an insert 6 which is bolted to the mould table 4 and may thus be exchanged (FIG. 5). It is normal that a mould table 4 may last for a plurality of mould inserts 6 which are then exchanged following wear.

Normally, a mould insert 6 for paving bricks is made of a steel plate; FIG. 7 shows a mould insert 6. Traditionally, this is cut from a steel plate, and individual cells 8 are cut out for forming and filling the entire production area. Subsequently, the insert edge is machined for being mounted in the mould table 4, and the individual cell holes 8 are machined to the correct tolerances. After that, the entire insert is tempered, thus relatively extensive works all in all.

By casting, a great material saving may be achieved as compared with conventional cutting out and subsequent machining.

By built-up moulds, which are traditionally used by other types of concrete article products than paving bricks, the mould is built up from plates and machines parts that are welded or bolted together with the mould frame. This type of mould lower parts traditionally implies much welding.

The invention is about casting the entire upper part 10 in one piece (FIG. 3), possibly in several pieces, e.g. top plate 12 and top rail 14 as a first piece which is then bolted together (FIG. 4) with the pressing pistons 16, where the legs 18, the foot plates 20 and possibly the thrust plates 22 are cast into a second piece. By casting in one piece, the upper part 10 may either be cast with integrated thrust plates 22 which then, after light machining, is tempered. Or Be upper part 10 may be cast in one piece without thrust plates 22 which are then made separately and bolted onto the foot plates 20 of the individual legs.

By casting, the lower part 2 can be made in one piece by the individual cell apertures 8 being cast immediately and thus only need minor machining before the cell walls are tempered (FIG. 5). Alternatively, the mould table 4 is cast separately (FIG. 6), and the mould insert 6 may be cast (FIG. 7) so that there is only need of minor machining before tempering or coating of the cell walls and the side of the partitionings between individual cells facing the upper part.

The whole idea is about removing weldings from elements that formed part of upper and lower parts of the mould equipment. Besides that the casting itself removes all weldings, which is very costly by itself, there is also achieved a great material saving, particularly on the lower part with normally is made of solid steel.

Furthermore, the mould, upper as well as lower part, may be recycled by remelting.

In short, it is important to understand that the invention is not limited to the above described embodiments, but that the invention can be utilised in combination with welded parts, depending on which embodiments of the mould equipment are desired, but this does not alter the inventive aspect of using entirely cast mould parts for making mould equipment with a resource consumption which is reduced by more than ⅓.

### List of Reference Numbers:

2 lower part

4 mould table

6 mould insert

8 open cells

10 upper part

12 top plate

14 top rail

15 intermediate plate

16 pressing pistons

18 legs on 16

20 foot plates

22 lower thrust plates

1. A method for making mould equipment for concrete casting machines of the kind typically used for making block bricks for pavement and wall construction, and including an lower part constituted by a mould table in which is provided at least one cell divided mould insert with cells that are open upwards as well as downwards, the cells defining the desired basic shape of individual bricks, and a corresponding upper part that includes a top rail from a top plate and has pressing pistons in the shape of legs projecting downwards from at least one intermediate plate and provided with foot plates, the undersides of which include lower thrust plates interacting with respective underlying cells in the lower part and thereby are useful counter hold for the castings during vibration and for downward ejection of the castings from the cells, wherein the individual parts comprised by the mould equipment, including such as top plate, top rail upper part, legs, foot plates, thrust plates, mould table, cell divided mould insert or inserts, lower part, are cast in at least one casting process.

2. A method for making mould equipment for concrete casting machines according to claim 1, wherein the top plate and the top rail are cast in a common casting process.

3. A method for making mould equipment for concrete casting machines according to claim 1, wherein the top plate and the top rail and the legs are cast in a common casting process.

4. A method for making mould equipment for concrete casting machines according to claim 1, wherein the top plate and the top rail, the legs and the foot plates are cast in a common casting process.

5. A method for making mould equipment for concrete casting machines according to claim 1, wherein the top plate and the top rail, the legs, foot plates and thrust plates are cast in a common casting process.

6. A method for making mould equipment for concrete casting machines according to claim 1, wherein the mould table and the mould insert are cast in a common casting process.

7. A method for making mould equipment for concrete casting machines according to claim 1, wherein the individual parts/items cast in the casting process are formed by a cast iron alloy.

8. A method for making mould equipment for concrete casting machines according to claim 1, wherein the individual parts/items cast by the casting process are subjected to a finishing treatment for removing burrs, scales etc.

9. A method for making mould equipment for concrete casting machines according to claim 8, wherein the finishing treatment is constituted by grinding and/or sandblasting, and/or polishing or similar treatment.

10. A method for making mould equipment for concrete casting machines according to claim 1, wherein the foot plates and/or the thrust plates in the upper part and the individual cells in the mould insert are tempered.

11. A method for making mould equipment for concrete casting machines according to claim 1, wherein the foot plates and/or the thrust plates in the upper part, and the individual cells in the mould insert are coated with carbide.

12. Mould equipment for concrete casting machines of the kind typically used for making block bricks for pavement and wall construction, and including a lower part constituted by a mould table in which is provided a cell divided mould insert with cells that are open upwards as well as downwards, the cells defining the desired basic shape of individual bricks, and a corresponding upper part that includes a top rail from a top plate and has pressing pistons in the shape of legs projecting downward from at least one intermediate plate and provided with foot plates, the undersides of which include lower thrust plates interacting with respective underlying cells in the lower part and thereby are useful counter hold for the castings during vibration and for downward ejection of the castings from the cells, wherein individual parts comprised by the mould equipment, including such as top plate, top rail, intermediate plate, pressing pistons, upper part, legs, foot plates, thrust plates, are constituted by at least one cast element.

13. Mould equipment for concrete casting machines according to claim 12, wherein the side faces of the thrust plates oriented against the mould table have projections and recesses.

14. Mould equipment for concrete casting machines according to claim 12, wherein the mould table is constituted by at least one cast element.

15. Mould equipment for concrete casting machines according to claim 12, wherein the cell divided mould insert is constituted by at least one cast element.

16. Mould equipment for concrete casting machines according to claim 12, wherein the mould table and the cell divided mould insert are constituted by at least one cast element.

17. Mould equipment for concrete casting machines according to claim 12, wherein the entire mould lower part is constituted by at least one cast element.

18. Mould equipment for concrete casting machines according to claim 12, wherein the cast elements are subjected to a finishing treatment for removing burrs, scales etc. by grinding and/or sandblasting, and/or polishing or similar treatment.

19. Mould equipment for concrete casting machines according to 12, wherein the foot plates and/or the thrust plates in the upper part and the individual cells in the mould insert are tempered.

20. Mould equipment for concrete casting machines according to claim 12, wherein the foot plates and/or the thrust plates in the upper part and the individual cells in the mould insert are coated with carbide.
